(19) United States
(12) Patent Application Publication
(10) Pub. No.: US 2019/0255731 A1
(43) Pub. Date: Aug. 22, 2019

(54) RECONSTITUTED WOOD PANEL WITH NATURAL WOOD GRAIN AND MANUFACTURING METHOD THEREOF

(71) Applicant: ANJI BROAD IMPORT AND EXPORT TRADE CO., LTD., Huzhou, Zhejiang (CN)

(72) Inventors: Bo HU, Huzhou, Zhejiang (CN); Qian HU, Huzhou, Zhejiang (CN)

(21) Appl. No.: 16/329,211

(22) PCT Filed: Jul. 25, 2017
(86) PCT No.: PCT/CN2017/094235

§ 371 Date: Feb. 27, 2019

(30) Foreign Application Priority Data
Aug. 30, 2016 (CN) 201610759583.5

(51) Int. Cl. B27N 3/18; B27D 1/04; B32B 21/04; B32B 21/14; B32B 7/12; B27N 3/00; E04C 2/24; E04F 15/04

(52) U.S. Cl. CPC B27N 3/18; B27D 1/04; B32B 21/042; B32B 21/14; B32B 2471/00; B27N 3/002; E04C 2/24; E04F 15/045; B32B 2307/732; B32B 7/12

(57) ABSTRACT

The present invention relates to a reconstituted wood panel, and more particularly to a reconstituted wood panel with natural wood grain and manufacturing method thereof. The reconstituted wood panel with natural wood grain of the present invention is manufactured by peeling or slicing the logs to obtain veneers with thickness of 3˜20 mm, and then impregnating with adhesive and hot pressing. The compression ratio is ≥10%, and the density is 0.7˜1.3 g/cm3, and the thickness swelling rate is ≤3.0% and the internal bonding strength is ≥3.0 MPa. By comparing the sawn wood board of the same tree species, the density of the reconstituted wood panel with natural wood grain is increased by 10% or more, and the thickness swelling rate is reduced by 20% or more, and the internal bonding strength has a growth of 35% or more. The panel of the present invention is manufactured by firstly peeling or slicing to obtain thick veneer(s) with splitting injury, and then impregnating with the adhesive to repair splits of veneers. The panel has advantages of good toughness, high strength, good dimensional stability, low sawline wastage, and short drying time, high production efficiency, low energy consumption and being environmentally friendly.

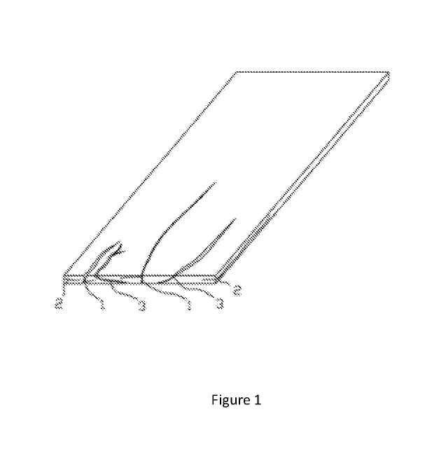

### BACKGROUND

### Technical Field

The present invention relates to a reconstituted wood panel, and more particularly to a reconstituted wood panel with natural wood grain and manufacturing method thereof.

### Technical Background

Solid wood flooring is manufactured by processing the logs through cutting, sawing, drying, etc. The disadvantages are that the production cycle is long, and it usually takes more than one month to dry the solid flooring. Engineered hardwood floor is a panel with a structure of three or more layers formed by compositing and laminate the top layer and other wood veneers. The top layer is obtained by peeling, slicing or sawing. During the manufacturing, it needs a lot of veneers to conduct lamination, and there are problems of lots of sawing wastage, large amount of glue, high release of formaldehyde, unstable bonding strength and others.

For example, the Chinese invention patent with the authorization number of CN103448127B discloses a manufacturing method of veneer laminated panel for decoration. The method comprises the following steps: boiling and softening the low-grade logs, then peeling and cutting into wood veneers and drying; impregnating half of the wood veneers with phenolic resin for 3˜10 min; drying at 50˜80° C. for 1˜1.5 hours; interval parallel grain laying-up the unimpregnated wood veneers and impregnated ones; placing the slab for 10˜30 min, and then sending the slab to the pre-presser to conduct pre-pressing for 3˜10 min; sending the above slab to the hot-presser for hot-pressing; natural cooling, and sawing to the equal-width slats with certain thickness, and then obtaining the veneer laminated panel for decoration.

The use of thick veneer for manufacturing veneer laminated panel is advantageous for the production process and the cost reduction. Due to the increase of the veneer thickness, the number of veneer layers can be reduced if manufacturing the LVL (Laminated Veneer Lumber) with the same thickness, thereby the glue amount applied to the veneers can be decreased and the environmental pollution can be reduced. Besides, the time for prepressing, hot-pressing and laying-up is also greatly reduced, and the production efficiency is improved.

However, there are few studies on the peeling of thick veneers in the prior art, because the thicker the peeled veneer, the easier the panel splits are to occur in the veneers. The panel splits can be obvious torn, and lateral, longitudinal and oblique ones. They can also be less obvious recessive splits. The recessive split injury can be found when the veneer is bent along the width direction. The thicker the veneer manufactured by peeling is, the greater the squeezing force between the cutter and the wood. The squeezing force is similar to the destructive one of rub. Moreover, when the thick veneers are peeled from the log body, some of the materials is actually torn, so that a small portion of the thick peeled veneers will be fluffed. What's more, they have more splits, and the surfaces are severely uneven. Besides, there are phenomena that the layers are separated. So generally they cannot be directly used for surface decoration, and doing this will affect the value of products. For example, it is impossible to peel a veneer with thickness of 10 mm using eucalyptus log without splits.

### Technical Problems

The present invention aims to solve the above problems, so it provides a reconstituted wood panel with natural wood grain. The panel is made from thick veneers by peeling or slicing, and it can be rapidly dried. It also has excellent dimensional stability and internal bonding strength, as well as high density.

### Solutions to Problems

### Technical Solution

The technical solution of the present invention to solve the above problems is as follows.

The reconstituted wood panel with natural wood grain of the present invention is manufactured by peeling or slicing the logs to obtain veneers with thickness of 3˜20 mm, and then impregnating with adhesive and hot pressing; the compression ratio of the said reconstituted wood panel is ≥10%; the reconstituted wood panel is tested according to the standard “GB/T 17657-2013 Test methods of evaluating the properties of wood-based panels and surface decorated wood-based panels” and “LY/T 1984-2011 Reconstituted wood flooring”, and the density is 0.7˜1.3 g/cm³, and the thickness swelling rate is ≤3.0% and the internal bonding strength is ≥3.0 MPa; by comparing testing results of the said reconstituted wood panel and the sawn wood board of the same tree species in accordance with “GB/T 17657-2013 Test methods of evaluating the properties of wood-based panels and surface decorated wood-based panels”, the density is increased by 10%, and the thickness swelling rate is reduced by 20% or more, and the internal bonding strength has a growth of 35% or more.

The other object of the present invention is to provide a manufacturing method of the reconstituted wood panel with natural wood grain, of which the technical solution is as follows.

The manufacturing method of reconstituted wood panel with natural wood grain comprises the following steps:
a. peeling or slicing the logs to obtain Veneer A with thickness of 3˜20 mm. which has splitting injury or injuries;
b. drying said Veneer A;
c. impregnating said Veneer A with the adhesive; and
d. repairing the splits of said Veneer A;
   wherein, the said splits repairing process is specifically: firstly, lateral pressuring the Veneer A to make longitudinal or oblique splits to be closed or mostly closed in the width direction of Veneer A, and to repair most of the longitudinal splits and the longitudinal portion of the oblique splits; then, hot pressing Veneer A up and down in the vertical direction to eliminate the transverse or oblique splits in the thickness direction of Veneer A, and to repair the transverse splits and the transverse portion of the oblique splits, and simultaneously repair the longitudinal splits and the longitudinal portion of the oblique splits; and continuing hot pressing to reduce the thickness, and improve the density of Veneer A; and then maintaining the pressure and temperature to make the adhesive impregnating into the Veneer A being completely cured and make the repaired splits being solid, and then obtaining the said reconstituted wood panel with natural wood grain, which has stable properties.

In the above technical solution of the present invention, the Veneer A with splitting injury or injuries means that the split(s) appears on the Veneer A, and the one that has a relatively greater degree is referred to as a torn. The split(s) may be caused by the extrusion of the cutter or tearing of the log during peeling or slicing the log to prepare thick veneers, or by shrinking of the log before peeling or slicing due to water loss. These splits may be transverse, longitudinal or oblique ones. Usually, the loss of water and dryness of the log will produce radial radiation and axially extending splits, which makes the log is extremely easy to be cleft along the splits by the tool such as an axe. Most of the splits will become longitudinal or oblique ones after peeling the log to veneer(s). However, splits caused by peeling or slicing are mostly transverse or oblique ones, and of course there are some longitudinal ones. No matter the splits are longitudinal, transverse or oblique ones, they are nearly parallel to the direction of veneer fibers. Among them, the transverse split is also called spalling, and it is reflected in the thickness direction of the veneer; the longitudinal split can be shown in the width direction of the veneer; while the oblique split is reflected in the thickness and width directions of the veneer.

There are various reasons for the occurrence of splits, in addition to the causes of peeling or slicing, it is also related to tree species, process, dryness of logs, etc., and closely related to thickness control. When the factors, such as the tree species, the peeling process, dryness of logs, are relatively constant, the greater the thickness of the veneer, the more likely it is to produce obvious, inconspicuous or invisible splits. Therefore, the thick veneers obtained by peeling or slicing are not suitably used as the top layer material of decoration panels because of splits.

In addition to the splitting injury or injuries, the front and back sides of the thick veneer are also likely to have a large number of obvious irregularities, which are caused by the tear. The irregularities exhibit a distinct linearity, the principle of which is equivalent to the tear grain formed on the cleft surface when chopping firewood using an axe. The tear injury causes the cleft surface of the firewood to show obvious irregularities. That is to say, some of the materials are actually torn off when cutting the thick veneer(s) from the wood body, so that a small portion of the thick peeled or sliced veneer(s) is fluffed and has more splits. Besides, the surface is severely uneven. And there is a phenomenon of stratification.

However, for the panel with splitting injury or injuries, whether the injury is tear grain, extrusion injury or natural cracking injury, and whether it is brought by the cracking of logs or from the cutter, softening degree of logs, the thickness control of logs, etc., it is not important in the above technical solution of the present invention. Because though the thick veneer has recessive, inconspicuous or obvious splitting injury or obvious irregularities on the surface due to tearing, the splitting injury or injuries will be repaired and the obvious irregularities will be flattened after treating the thick veneer with subsequent impregnating and hot pressing of the present invention.

The split repairing technique of Veneer A is the primary feature of the present invention. The peeling is a cutting process that the fixed axis rotation of the lumber section is conducted, and a linear feeding motion is performed when the cutting edge is rotated to be parallel to the axis of the wood section, and then the cutting process is carried out along the direction of the wood annual ring. Therefore, the Veneer A obtained by the peeling process corresponds to a panel formed by multi-layer fiber bundles side by side, and the direction of fiber bundles is the longitudinal direction of Veneer A. Consequently, split or torn is the separation of fiber bundles, and adjacent fiber bundles are torn in the peeling, not because the fiber bundles are broken or fractured. So the strength of Veneer A is not lost after repairing the splits, and it is remarkably improved for the fiber bundles are glued and squeezed more tightly.

Similarly, the sliced veneer is also a panel formed by multi-layer fiber bundles side by side, and the direction of fiber bundles is the longitudinal direction of Veneer A. Its strength is also remarkably improved after repairing the splits.

As a preferred option of the above technical solution, in step a, peeling or slicing the logs to obtain Veneer A with thickness of 3˜20 mm, which has splitting injury or injuries; the drying treatment in step b is to control the moisture content of Veneer A to 7˜15%; in step c, the said adhesive is one of the water soluble phenolic resin glue, water soluble urea-formaldehyde resin glue, polyurethane glue or the mixed liquid of water soluble phenolic resin glue and nitrile rubber emulsion.

As a preferred option of the above technical solution, in step b, a continuous conveying dryer is used for rapid drying at the drying temperature of 75˜120° C., the drying time of 60˜300 min, in order to control the moisture content of Veneer A to 7˜15%.

When using the traditional sawing process to produce panels with thickness of 15 mm or more, in order to avoid warping or cracking during drying, it usually needs to perform multiple cycles of wetting-drying-wetting-drying in the drying process, so this increases the energy consumption and cost, and also prolongs the drying time. While, adopting the process of the present invention, rapid drying of the veneer may be carried out after peeling or slicing, even if warping and cracking occurs in the drying, they can be repaired in the subsequent splitting repairing step.

The ratio of water soluble phenolic resin and nitrile rubber emulsion is controlled based on the principle that the adhesive strength of the panel is focused on and the flexibility is also concerned. The water soluble phenolic resin functions as a blocking after curing, which shows the bonding strength of panels; the nitrile rubber emulsion imparts elasticity and flexibility to Veneer A. That is to say, the toughness and strength of Veneer A are simultaneously imparted by compounding the water soluble phenolic resin and nitrile rubber emulsion. And in specific, the toughness and strength of Veneer A can be compounded according to the actual needs of users. Experiments have revealed that Veneer A has good flexibility and elasticity using the mixed liquid of 25% solids content water soluble phenolic resin and 45% solids content nitrile rubber emulsion when the nitrile rubber emulsion is more than 5% by weight of water soluble phenolic resin. Therefore, in the present invention, the ratio of the water soluble phenolic resin and nitrile rubber emulsion is not specifically limited.

Preferably, in the mixed liquid of water soluble phenolic resin and nitrile rubber emulsion, the nitrile rubber emulsion accounts for 5-15% by weight of water soluble phenolic resin in which the solids content is 20˜45%.

More preferably, in the mixed liquid of water soluble phenolic resin and nitrile rubber emulsion, the nitrile rubber emulsion accounts for 5˜10% by weight of water soluble phenolic resin in which the solids content is 20˜30%.

As a preferred option of the above technical solution, in step c, the said adhesive is the water soluble phenolic resin, or the mixed liquid of water soluble phenolic resin and nitrile rubber emulsion; the pressure impregnating method is used, and the impregnating pressure is controlled to 0.3˜1.0 MPa; there is a secondary drying step between step c and d, specifically: drying the impregnated Veneer A at the temperature of 60˜90° C. to a moisture content of 6˜12%; in step d, when performing hot pressing, the temperature of the press plate surface is controlled to 125˜140° C. and the vertical pressure acting on the panel is at least 15 kg/cm².

As another preferred option of the above technical solution, in step c, the said adhesive is water soluble urea-formaldehyde resin; there is a secondary drying step between step c and d, specifically: drying the impregnated Veneer A at a low temperature below 50° C. to a moisture content of 20% or less; in step d, the secondary dried Veneer A is promptly sent to a presser for splits repairing and curing at the temperature of 90˜115° C.

As a further preferred option of the above technical solution, in step c, the said adhesive is polyurethane; pre-treatment of Veneer A is conducted before impregnating polyurethane, and the said pre-treatment comprises the following steps: (1) immersing Veneer A in alkaline water; (2) rinsing after boiling, and dredging the pores of Veneer A by a vacuum suction method; (3) drying Veneer A to a moisture content of 10% or less; (4) pressing the polyurethane glue into Veneer A by the pressure impregnating method; (5) curing at room temperature after pressing Veneer A by the method of constant mold width and the method of constant mold thickness, and taking out the panel.

When the polyurethane is used as the adhesive, there is a problem that it is difficult to enter the veneer. When injecting polyurethane, it is also cured at the same time. As a result, it is relatively easy to inject the polyurethane at the beginning, but in the later, it is difficult for the polyurethane to enter the veneer. In order to solve this problem, it is awkward to simply increase the pressure or prolong the impregnating time. So the inventors have proposed a scheme for dredging panel pores to improve the impregnating effect. After immersing in alkaline water for enough time, some cellulose and hemicellulose soften, and some tyloses react with the alkali, resulting in that the pores of the wood are dredged after boiling and rinsing. This is beneficial to the implementation of the impregnating scheme. The facts also prove that such a scheme is reasonable and effective.

As a preferred option of the above technical solution, in step d, the method of constant mold width is used when repairing the longitudinal splits and the longitudinal portion of the oblique splits; the method of constant mold thickness is employed when repairing the transverse splits and the transverse portion of the oblique splits.

The densities from different parts of the same log are different, so even the veneers obtained by peeling the same log have different densities. The slight differences of densities can also vary the widths of final products. For example, a eucalyptus log veneer with width of 20 cm, after treatment of drying, impregnating and hot pressing, will have a reduced width due to the lateral pressure applied in the hot pressing, especially when the densities are inconsistent, the width may shrink to 19 cm or 19.8 cm. To ensure the products have uniform sizes, the widths of veneers are needed to be fixed. The traditional solution is cutting the veneers with different widths to obtain veneers with the same width. But this method not only adds processes, but also wastes materials, and produces wastes. To solve this problem, we adopt the method of constant mold width, which is, adding a fixed width strut between the frames of the mold. The fixed width strut can be retractable, and it has controllable minimum compression length and the two ends are connected on the frames of the mold. After placing the veneers in the mold, the widths of veneers are adjusted by one-side lateral pressuring or two-sides lateral pressuring. When the veneers are compressed to match the minimum compression length of the retractable fixed width strut, it is offset by the fixed width strut of the mold, so the widths of veneers are no longer compressed. The widths of the compressed panels manufactured by this method are the same, as the minimum compression length of the fixed width strut of the mold, so it is called the method of constant mold width.

The method of constant mold thickness, that is, the veneers are placed into a mold having a smaller thickness than that of the veneers, and they are compressed when the press plate of the presser applies pressure on them. If the veneers are compressed to match the thickness of the frames, the pressure from the press plate is offset by the mold frames with fixed thickness, so the veneers are no longer compressed. The thicknesses of the compressed panels manufactured by this method are the same as the frame thickness of the mold, so it is called the method of constant mold thickness.

In the above technical solution, firstly adjusting the widths of veneers by the method of constant mold width not only repairs most longitudinal splits and the longitudinal portions of some oblique splits, but also adjusts the linearity of veneers. Then, the thicknesses of veneers are compressed by the method of constant mold thickness. Repairing splits and improving densities are mainly completed in this process. Of course, the above process of repairing spits is carried out at the beginning of curing of the adhesive or during the curing process. Besides, in order to ensure the quality of the final products, it is necessary to maintain the pressure for a certain time until the curing of the adhesive is completed.

As a preferred option of the above technical solution, when performing lateral pressuring, the steel plate is firstly closed to the thickness of the veneers to fix them, and the mold is fixed to width and then pressed into position.

As a preferred option of the above technical solution, in step d, placing one or more Veneer(s) A in the mold frame, a presser is used to compress one or more Veneer(s) A by two-sides or one-side lateral pressuring until the width(s) of Veneer(s) A is equal to the width of the mold frame; then fixed thickness strongly pressing by a hot presser is performed to reduce the thickness(es) of Veneer(s) A to that of the frame mold with fixed thickness.

The fixed thickness strongly pressing in vertical pressing is mainly to make the fiber bundles at different thickness layers become tighter, so that the density of Veneer A can be increased. At the same time, the fiber bundles can be squeezed to repair splits. Lateral pressuring is mainly to make the fiber bundles of the same layer become tighter, so the fiber bundles can be squeezed to repair splits. And the width and linearity of Veneer A can also be adjusted.

Since the reconstituted wood panel in the prior art is formed by rolling compaction and restructuring or peeling the wood into thin veneers, and applying adhesive, then randomly stacking and laying-up, and finally compression molding at high pressure and temperature, so the original grain of the wood is damaged to a certain extent. While in the present invention, the veneers are prepared by peeling or slicing. This does not break up the fibers of the panel, nor randomly fold the veneers into the mold for compression molding. And the splits of veneers with splitting injury or injuries, which are produced by peeling or slicing, are repaired by impregnating and compressing. Therefore, the natural wood grain is kept very well, and the density is increased and the performance is more stable. The utilization rate of wood has been greatly improved.

### Beneficial Effects of the Invention

### Beneficial Effects

1. The present invention creatively proposes a method for manufacturing panels by firstly peeling or slicing to obtain thick veneer(s) with splitting injury, and then impregnating to repair splits of veneers. The panels prepared by the scheme has advantages of good toughness, high strength, good dimensional stability, low sawline wastage, and short drying time, high production efficiency, low energy consumption and being environmentally friendly. Besides, the width of product can also be increased, which is not possible with traditional sawn timber.

2. In the impregnating of the present invention, the adhesive can be water soluble phenolic resin or the mixture of water soluble phenolic resin and nitrile rubber emulsion. The water soluble phenolic resin provides strength after curing, and the nitrile rubber emulsion provides toughness after curing, so the final product of the present invention has good strength and toughness, and improved quality.

3. Since the peeling is a cutting process that the fixed axis rotation of the lumber section is conducted, and a linear feeding motion is performed when the cutting edge is rotated to be parallel to the axis of the wood section, and then the cutting process is carried out along the direction of the wood annual ring, the Veneer A obtained by the peeling process is equivalent to a panel in which a multiple layers of fiber bundles are formed side by side. The splits or torns are separations between the fiber bundles, and adjacent fiber bundles are torn in the peeling process, not because the fiber bundles are fractured or broken. As a result, the strength of Veneer A is not be reduced but remarkable improved after repairing the splits, for the fiber bundles are glued and the fiber bundles are squeezed more tightly.

4. Since the reconstituted wood panel in the prior art is formed by rolling compaction and restructuring or peeling the wood into thin veneers, and applying adhesive, then randomly stacking and laying-up, and finally compression molding at high pressure and temperature, so the original grain of the wood is damaged to a certain extent. While in the present invention, the veneers are prepared by peeling or slicing. This does not break up the fibers of the panel, and the splits of veneers are naturally produced in the peeled or sliced panel, and they are repaired by impregnating and compressing. During repairing splits process, compression up and down and lateral pressuring are carried out at the same time, so the natural wood grain is kept very well, and the density is increased and the performance is more stable.

5. The compression process of the present invention not only repairs the splits, but also improves the hardness and density of the panel; the density of the panel can be finally increased by more than 10%.

### BRIEF DESCRIPTION OF THE DRAWINGS

Sole FIGURE is the schematic view showing the panel splits of Veneer A in the present invention.

In the Sole FIGURE, 1—longitudinal split, 2—transverse split, and 3—oblique split.

### PREFERRED EMBODIMENTS CARRYING OUT THE PRESENT INVENTION

### Preferred Embodiments of the Present Invention

The reconstituted wood panel with natural wood grain is manufactured by the following method:
a. cutting the oak logs from northeast China into lumber sections with length of 2000 mm, and cooking to soften the wood, and then oak veneers with length of 2000 mm, width of 140 mm and thickness of 16 mm being obtained by a peeling process;
b. placing the veneers into a dryer at 75° C. to control the moisture content of 11%, and taking them out; wherein at this time, the lengths of the veneers are basically maintained at 2000 mm, while the widths have different shrinkages, ranging from 134 mm to 136 mm, and the thicknesses vary from 15.2 mm to 15.4 mm;
c. putting the veneers into a container pre-filled with compatibility of water and other two solutions, respectively 30% solids content water-soluable phenolic resin and 45% solids content nitrile rubber emulsion, wherein the content of nitrile rubber emulsion is 7% of that of water-soluable phenolic resin; closing the door of the container, feeding into compressed air, and holding the pressure for 120 minutes when the pressure gauge shows 0.6 MPa; then expelling the exhaust and opening the door to take out the veneers.
d. checking the veneers to see that the mixed liquid has been permeated, and filtering the excess liquid;
e. sending the veneers to a drying kiln at 70° C. to dry until the moisture content is 10%, then taking them out, and at this time, checking the size of veneers to see that there are no significant changes of the lengths, being 2000 mm, and the widths have an error, about 132-136 mm, and the thicknesses also have an error, about 15.0-15.3 mm;

f. placing the veneers into a hot presser with a mold of fixed thickness of 13.4 mm, and width of 130 mm; wherein, the hot presser is a 4-layer one, and each layer is placed with 4 veneers, namely a total of 16 veneers;
g. adjusting the temperature of the press plate surface to 133-135° C.;
h. after the veneers are placed into the mold, firstly, closing the hot press steel plate to adhere to the veneers, then setting the width of the mold to 130 mm for side pressuring, and then hot pressing vertically up and down to the thickness of the veneers being 14 mm; taking out the veneers after curing for 18 minutes at the above pressure and temperature; wherein, the longitudinal splits 1, transverse splits 2 and oblique splits 3 as shown in Sole FIGURE are all repaired during the process; and
i. sanding the veneers to obtain finished oak hard veneers, which have lengths of 2000 mm, uniform widths of 130 mm and thicknesses of 13 mm.

### EMBODIMENTS OF THE INVENTION

### Embodiment 1

The reconstituted wood panel with natural wood grain is manufactured by the following method:
a. cutting the oak logs from northeast China into lumber sections with length of 2000 mm, and cooking to soften the wood, and then oak veneers with length of 2000 mm, width of 250 mm and thickness of 6.1˜6.5 mm being obtained by a peeling process;
b. placing the veneers in a dryer at 75° C. to control the moisture content of 10˜11%, and taking them out; wherein at this time, the lengths of the veneers are basically maintained at 2000 mm, while the widths have different shrinkages, ranging from 238 mm to 242 mm, and the thicknesses vary from 5.8 mm to 6.2 mm;
c. putting the veneers into a pressure vessel pre-filled with compatibility of 25% solids content water soluble phenolic resin adhesive, and closing the vessel door;
d. feeding into compressed air, and when the pressure gauge shows 0.4 MPa, holding for 60 minutes; then expelling the exhaust and opening the door to take out the veneers and placing for 1.5 hours to filter out the excess liquid in the surface of veneers;
e. sending the veneers to the 75° C. dryer to dry until the moisture content is 10% then taking them out, and at this time, checking the size of veneers to see that there are no significant changes of the length, being 2000 mm, and the widths have an error, about 237-240 mm, and the thicknesses also have an error, about 5.6-6.0 mm;
f. placing the veneers into a hot presser with a mold of fixed thickness of 5.0 mm, and width of 235 mm; wherein, the hot presser is a 4-layer one, and each layer is placed with 4 veneers, namely a total of 16 veneers;
g. adjusting the temperature of the press plate surface to 134-137° C.;
h. after the veneers are placed into the mold, firstly, closing the hot press steel plate to adhere to the veneers, then setting the width of the mold to 235 mm for side pressuring, and then hot pressing vertically up and down to the thickness of the veneers being 5.0 mm; taking out the veneers after curing for 12 minutes at the above pressure and temperature; wherein, the longitudinal splits 1, transverse splits 2 and oblique splits 3 as shown in Sole FIGURE are all repaired during the process; and
i. sanding the veneers to obtain finished oak hard veneers, which have lengths of 2000 mm, uniform widths of 235 mm and thicknesses of 4.6 mm.

### Embodiment 2

The reconstituted wood panel with natural wood grain is manufactured by the following method:
a. cutting the eucalyptus logs from Guangxi Province, China into lumber sections with length of 2000 mm, and cooking to soften the wood, and then eucalyptus veneers with length of 2000 mm, width of 600 mm and thickness of 6.2 mm being obtained by a peeling process;
b. placing the veneers in a dryer at 75° C. to control the moisture content of 10%, and taking them out; wherein at this time, the lengths of the veneers are basically maintained at 2000 mm, while the widths have different shrinkages, ranging from 553 mm to 580 mm, and the thicknesses vary from 5.7 mm to 6.0 mm;
c. putting the veneers into a pressure vessel pre-filled with compatibility of 40% solids content water soluble urea-formaldehyde resin adhesive, and closing the vessel door;
d. feeding into compressed air, and when the pressure gauge shows 0.6 MPa, holding for 60 minutes; then expelling the exhaust and opening the door to take out the veneers and placing for 1.0 hours to filter out the excess liquid in the surface of veneers;
e. sending the veneers to the 45° C. dryer to dry until the moisture content is 17% then taking them out, and at this time, checking the size of veneers to see that there are no significant changes of the length, being 2000 mm, and the widths have an error for the logs from different parts have different original densities, about 553-575 mm, and the thicknesses also have an error, about 5.6-5.8 mm;
f. placing the veneers into a hot presser with a mold of fixed thickness of 5.0 mm, and width of 550 mm; wherein, the hot presser is a 4-layer one, and each layer is placed with 2 veneers, namely a total of 8 veneers;
g. adjusting the temperature of the press plate surface to 96-100° C.;
h. after the veneers are placed into the mold, firstly, closing the hot press steel plate to adhere to the veneers, then setting the width of the mold to 550 mm for side pressing, and then hot pressing vertically up and down to the thickness of the veneers being 5.0 mm; taking out the veneers after kept for 10 minutes at the above pressure and temperature; wherein, the longitudinal splits 1, transverse splits 2 and oblique splits 3 as shown in Sole FIGURE are all repaired during the process; and
i. sanding the veneers to obtain finished eucalyptus hard veneers, which have lengths of 2000 mm, uniform widths of 550 mm and thicknesses of 4.6 mm.

### Embodiment 3

The reconstituted wood panel with natural wood grain is manufactured by the following method:
a. cutting poplar logs from Shandong Province into lumber sections with length of 1000 mm, and cooking to soften the wood, and then poplar veneers with length of 1000 mm, width of 600 mm and thickness of 6.2 mm being obtained by a peeling process;
b. immersing the veneers in alkaline aqueous solution for 3 hours at 80° C., and cooking in 90-95° C. water for 2 hours, then sending to a sealed tank for evacuation to dredge the fiber pores of wood, which is good for impregnating; then placing the veneers to 75° C. dryer to control the moisture content of 6%, and taking them out; wherein at this time, the lengths of veneers are 1000 mm without significant changes, while the widths have different shrinkages, ranging from 550 mm to 550 mm, and the thicknesses vary from 5.5 mm to 5.7 mm;
c. putting the veneers into a pressure vessel, and injecting the polyurethane liquid immediately, then closing the vessel door;
d. propelling the polyurethane liquid in the tank using a screw piston with the principle of medical hand push syringe to make the adhesive completely flood the veneers, and closing the top valve after expelling the exhaust; the screw continuing to advance the piston until the pressure gauge shows 1.0 MPa, and keeping the pressure for 60 minutes; then retreating the threaded top rod and opening the top valve to let the air in, and then opening the door at normal pressure, and taking out the veneers to filter out the excess liquid;
e. placing the veneers into a ten-layer presser coated with release agent, with a mold of fixed thickness of 5.3 mm, and width of 525 mm; wherein, each layer is placed with 2 veneers, namely a total of 20 veneers;
f. after the veneers are placed into the mold, firstly, closing the hot press steel plate to adhere to the veneers, then setting the width of the mold to 525 mm for side pressing, and then hot pressing vertically up and down to the thickness of the veneers being 5.3 mm; decompressing and taking out the veneers after kept for 12 hours at the above pressure after completely curing at room temperature; wherein, the longitudinal splits 1, transverse splits 2 and oblique splits 3 as shown in Sole FIGURE are all repaired during the process; and
g. sanding the veneers to obtain finished poplar hard veneers, which have lengths of 1000 mm, uniform widths of 525 mm and thicknesses of 5.0 mm.

As can be seen from Embodiment 3, the major difference between using polyurethane resin in Embodiment 3 and water soluble phenolic resin and urea-formaldehyde resin is that the presser does not need to be heated, and the volume loss of the final product is reduced, so the available material volume is increased. Injecting the polyurethane into the interior of the wood has a good filling effect, and it increases the density of the wood. Although the compression ratio is not 10%, but the degree of compactness of the wood is increased and the mechanical properties are also improved.

### Embodiment 4

The reconstituted wood panel with natural wood grain is manufactured by the following method:
a. cutting the oak logs from northeast China into lumber sections with length of 2000 mm, and cooking to soften the wood, and then oak veneers with length of 2000 mm, width of 140 mm and thickness of 16 mm being obtained by a peeling process;
b. placing the veneers in a dryer at 75° C. to control the moisture content of 11%, and taking them out; wherein at this time, the lengths of the veneers are basically maintained at 2000 mm, while the widths have different shrinkages, ranging from 134 mm to 136 mm, and the thicknesses vary from 15.2 mm to 15.4 mm;
c. putting the veneers into a container pre-filled with compatibility of water and other two solutions, respectively 30% solids content water-soluble phenolic resin and 45% solids content nitrile rubber emulsion, wherein the content of nitrile rubber emulsion is 7% of that of water-soluble phenolic resin; closing the door of the container, and feeding into compressed air, and holding the pressure for 120 minutes when the pressure gauge shows 0.6 MPa; then expelling the exhaust and opening the door to take out the veneers.
d. checking the veneers to see that the mixed liquid has been permeated, and taking out the veneers and filtering the excess liquid;
e. sending the veneers to a drying kiln at 70° C. to dry until the moisture content is 10% then taking them out, and at this time, checking the size of veneers to see that there are no significant changes of the lengths, being 2000 mm, and the widths have an error for the logs from different parts have different original densities, about 132-136 mm, and the thicknesses also have an error, about 15.0-15.3 mm;
f. placing the veneers into a hot presser with a mold of fixed thickness of 13.4 mm, and width of 130 mm; wherein, the hot presser is a 4-layer one, and each layer is placed with 4 veneers, namely a total of 16 veneers;
g. adjusting the temperature of the press plate surface to 133-135° C.;
h. after the veneers are placed into the mold, firstly, closing the hot press steel plate to adhere to the veneers, then setting the width of the mold to 130 mm for side pressing, and then hot pressing vertically up and down to the thickness of the veneers being 14 mm; taking out the veneers after curing for 18 minutes at the above pressure and temperature; wherein, the longitudinal splits 1, transverse splits 2 and oblique splits 3 as shown in Sole FIGURE are all repaired during the process; and
i. sanding the veneers to obtain finished oak hard veneers, which have lengths of 2000 mm, uniform widths of 130 mm and thicknesses of 13 mm.

Panels with uniform thickness and width are produced using the reconstituted wood panel with natural wood grain manufactured in the invention and the sawn wood board of the same tree species, and processed to a moisture content of 9˜10%, then tested according to the standard “GB/T 17657-2013 Test methods of evaluating the properties of wood-based panels and surface decorated wood-based panels” and “LY/T 1984-2011 Reconstituted wood flooring”. The results are shown in the following table:

[Number]
Comparison of test results of physical properties

| | | Test items and method | | | |
|---|---|---|---|---|---|
| | | Thickness | | | |
| | | swelling rate | | Internal | |
| | | (%) | | bonding | |
| | | Immersing in | Thermal cycling | strength | Density |
| | | water at 20° C. | Method 2 of GB/T | (MPa) | (g/cm³) |
| Specimen information | | for 24 hours | 17657-2013, 5 times | / | / |
| Oak log, | Embodiment 1 | 3.8 | No splits and no blister | 5.1 | 0.92 |
| Heilongjiang | | | on the surface. | | |
| Province | Sawn wood | 6.2 | No splits and no blister | 3.6 | 0.72 |
| | board | | on the surface. | | |
| Eucalyptus | Embodiment 2 | 4.2 | Slight splits and no | 3.8 | 0.80 |
| log, Guangxi | | | bister on the surface. | | |
| Province | Sawn wood | 5.1 | Slight splits and no | 2.8 | 0.60 |
| | board | | bister on the surface. | | |
| Poplar log, | Embodiment 3 | 0.2 | No splits and no blister | 7.6 | 0.60 |
| Shandong | | | on the surface. | | |
| Province | Sawn wood | 4.9 | No splits and no blister | 2.2 | 0.45 |
| | board | | on the surface. | | |
| Oak log, | Embodiment 4 | 2.9 | No splits and no blister | 6.3 | 1.04 |
| Heilongjiang | | | on the surface. | | |
| Province | Sawn wood | 5.2 | No splits and no blister | 3.6 | 0.72 |
| | board | | on the surface. | | |

It can be found that, by comparing the reconstituted wood panels with natural wood grain and the sawn wood boards of the same tree species, the physical and mechanical properties have different degrees of improvement. The products can be processed into floor, furniture and others with increased density, enhanced resistance to deformation and splits and reduced production costs. The manufacturing method in the present invention fully utilizes fast-growing wood and it saves energy. Besides, it is environmentally friendly. The products have a wide range of applications. There is a great significance to spread the manufacturing method.

1. A reconstituted wood panel with natural wood grain, characterized in that, manufactured by peeling or slicing the logs to obtain veneers with thickness of 3˜20 mm, and then impregnating with the adhesive and hot pressing; the compression ratio of the said reconstituted wood panel being ≥10%; the said reconstituted wood panel being tested according to “GB/T 17657-2013 Test methods of evaluating the properties of wood-based panels and surface decorated wood-based panels” and “LY/T 1984-2011 Reconstituted wood flooring”, and the density being 0.7˜1.3 g/cm³, and the thickness swelling rate being ≤3.0% and the internal bonding strength being ≥3.0 MPa; by comparing testing results of the said reconstituted wood panel and the sawn wood board of the same tree species in accordance with “GB/T 17657-2013 Test methods of evaluating the properties of wood-based panels and surface decorated wood-based panels” and “LY/T 1984-2011 Reconstituted wood flooring”, the density being increased by 10% or more, and the thickness swelling rate being reduced by 20% or more, and the internal bonding strength being increased by 35% or more.

2. A manufacturing method of the said reconstituted wood panel with natural wood grain according to claim 1, comprising the following steps:
a. peeling or slicing the logs to obtain Veneer A with thickness of 3˜20 mm, which has splitting injury or injuries;
b. drying said Veneer A;
c impregnating said Veneer A with the adhesive; and
d. repairing the splits of said Veneer A;
wherein, the said splits repairing process is specifically: firstly, lateral pressuring the Veneer A to make longitudinal or oblique splits to be closed or mostly closed in the width direction of Veneer A, and to repair most of the longitudinal splits and the longitudinal portion of the oblique splits; then, hot pressing Veneer A up and down in the vertical direction to eliminate the transverse or oblique splits in the thickness direction of Veneer A, and to repair the transverse splits and the transverse portion of the oblique splits, and simultaneously repair the longitudinal splits and the longitudinal portion of the oblique splits; and continuing hot pressing to reduce the thickness, and improve the density of Veneer A; and then maintaining the pressure and temperature to make the adhesive impregnating into the Veneer A being completely cured and make the repaired splits being solid, and then obtaining the said reconstituted wood panel with natural wood grain, which has stable properties.

3. The manufacturing method of reconstituted wood panel with natural wood grain according to claim 2, wherein, in step a, peeling or slicing the logs to obtain Veneer A with thickness of 3˜20 mm, which has splitting injury or injuries; the drying in step b is to control the moisture content of Veneer A to 7˜15%; in step c, the said adhesive is one of the water soluble phenolic resin glue, water soluble urea-formaldehyde resin glue, polyurethane glue or the mixed liquid of the water soluble phenolic resin glue and the nitrile rubber emulsion.

4. The manufacturing method of reconstituted wood panel with natural wood grain according to claim 3, wherein, in step b, a continuous conveying dryer is used for rapid drying at the drying temperature of 75˜120° C. and the drying time of 60˜300 min, in order to control the moisture content of Veneer A to 7˜15%.

5. The manufacturing method of reconstituted wood panel with natural wood grain according to claim 3, wherein, in the said mixed liquid of water soluble phenolic resin and nitrile rubber emulsion, the nitrile rubber emulsion accounts for 5˜15% by weight of water soluble phenolic resin in which the solids content is 45%.

6. The manufacturing method of reconstituted wood panel with natural wood grain according to claim 3, wherein, in step d, the method of constant mold width is used when repairing the longitudinal splits and the longitudinal portion of the oblique splits; the method of constant mold thickness is employed when repairing the transverse splits and the transverse portion of the oblique splits.

7. The manufacturing method of reconstituted wood panel with natural wood grain according to claim 3, wherein, in step d, placing one or more Veneer(s) A in the mold frame, a presser is used to compress one or more Veneer(s) A by two-sides or one-side lateral pressuring until the width(s) of Veneer(s) A is equal to the width of the mold frame; then fixed thickness strongly pressing by a hot presser is performed to reduce the thickness(es) of Veneer(s) A to that of the frame mold with fixed thickness.

8. The manufacturing method of reconstituted wood panel with natural wood grain according to claim 2, wherein, in step c, the said adhesive is the water soluble phenolic resin, or the mixed liquid of water soluble phenolic resin glue and nitrile rubber emulsion, and the solids content is 20˜45%; the pressure impregnating method is used, and the impregnating pressure is controlled to 0.3˜1.0 MPa; there is a secondary drying step between step c and d, specifically: drying the impregnated Veneer A at the temperature of 60˜90° C. to a moisture content of 6˜12%; in step d, when performing hot pressing, the temperature of the press plate surface is controlled to 125˜140° C. and the vertical pressure acting on the panel is at least 15 kg/cm².

9. The manufacturing method of reconstituted wood panel with natural wood grain according to claim 2, wherein, in step c, the said adhesive is water soluble urea-formaldehyde resin; there is a secondary drying step between step c and d, specifically: drying the impregnated Veneer A at a low temperature below 50° C. to a moisture content of 20% or less; in step d, the secondary dried Veneer A is promptly sent to a presser for splits repairing and curing at the temperature of 90˜115° C.

10. The manufacturing method of reconstituted wood panel with natural wood grain according to claim 2, wherein, in step c, the said adhesive is polyurethane; pre-treatment of said Veneer A is conducted before impregnating polyurethane, and the said pre-treatment comprises the following steps:
(1) immersing said Veneer A in alkaline water;
(2) rinsing after cooking, and dredging the pores of said Veneer A by a vacuum suction method;
(3) drying said Veneer A to a moisture content of 10% or less;
(4) pressing the polyurethane adhesive into said Veneer A by the pressure impregnating method; and
(5) curing at room temperature after pressing said Veneer A by the method of constant mold width and the method of constant mold thickness, and taking out the panel.

11. The manufacturing method of reconstituted wood panel with natural wood grain according to claim 2, wherein, in step b, a continuous conveying dryer is used for rapid drying at the drying temperature of 75˜120° C. and the drying time of 60˜300 min, in order to control the moisture content of Veneer A to 7˜15%.

12. The manufacturing method of reconstituted wood panel with natural wood grain according to claim 2, wherein, in the said mixed liquid of water soluble phenolic resin and nitrile rubber emulsion, the nitrile rubber emulsion accounts for 5˜15% by weight of water soluble phenolic resin in which the solids content is 45%.

13. The manufacturing method of reconstituted wood panel with natural wood grain according to claim 2, wherein, in step d, the method of constant mold width is used when repairing the longitudinal splits and the longitudinal portion of the oblique splits; the method of constant mold thickness is employed when repairing the transverse splits and the transverse portion of the oblique splits.

14. The manufacturing method of reconstituted wood panel with natural wood grain according to claim 2, wherein, in step d, placing one or more Veneer(s) A in the mold frame, a presser is used to compress one or more Veneer(s) A by two-sides or one-side lateral pressuring until the width(s) of Veneer(s) A is equal to the width of the mold frame; then fixed thickness strongly pressing by a hot presser is performed to reduce the thickness(es) of Veneer(s) A to that of the frame mold with fixed thickness.

15. The manufacturing method of reconstituted wood panel with natural wood grain according to claim 3, wherein, in step c, the said adhesive is the water soluble phenolic resin, or the mixed liquid of water soluble phenolic resin glue and nitrile rubber emulsion, and the solids content is 20˜45%; the pressure impregnating method is used, and the impregnating pressure is controlled to 0.3˜1.0 MPa; there is a secondary drying step between step c and d, specifically: drying the impregnated Veneer A at the temperature of 60˜90° C. to a moisture content of 6˜12%; in step d, when performing hot pressing, the temperature of the press plate surface is controlled to 125˜140° C. and the vertical pressure acting on the panel is at least 15 kg/cm².

16. The manufacturing method of reconstituted wood panel with natural wood grain according to claim 3, wherein, in step c, the said adhesive is water soluble urea-formaldehyde resin; there is a secondary drying step between step c and d, specifically: drying the impregnated Veneer A at a low temperature below 50° C. to a moisture content of 20% or less; in step d, the secondary dried Veneer A is promptly sent to a presser for splits repairing and curing at the temperature of 90˜115° C.

17. The manufacturing method of reconstituted wood panel with natural wood grain according to claim 3, wherein, in step c, the said adhesive is polyurethane; pre-treatment of said Veneer A is conducted before impregnating polyurethane, and the said pre-treatment comprises the following steps:
(1) immersing said Veneer A in alkaline water;
(2) rinsing after cooking, and dredging the pores of said Veneer A by a vacuum suction method;
(3) drying said Veneer A to a moisture content of 10% or less;
(4) pressing the polyurethane adhesive into said Veneer A by the pressure impregnating method; and
(5) curing at room temperature after pressing said Veneer A by the method of constant mold width and the method of constant mold thickness, and taking out the panel.
